(19) United States
(12) Patent Application Publication
(10) Pub. No.: US 2015/0236811 A1
(43) Pub. Date: Aug. 20, 2015

(54) WIRELESS COMMUNICATION DEVICE

(71) Applicant: KABUSHIKI KAISHA TOSHIBA, Tokyo (JP)

(72) Inventors: Koji AKITA, Yokohama Kanagawa (JP); Yukako TSUTSUMI, Kawasaki Kanagawa (JP); Koji OGURA, Tachikawa Tokyo (JP)

(73) Assignee: KABUSHIKI KAISHA TOSHIBA, Tokyo (JP)

(21) Appl. No.: 14/600,760

(22) Filed: Jan. 20, 2015

(30) Foreign Application Priority Data
Feb. 18, 2014 (JP) 2014-028442

(51) Int. Cl. H04K 3/00; H01Q 1/24

(52) U.S. Cl. CPC H04K 3/65; H01Q 1/24; H04K 3/68

(57) ABSTRACT

According to an embodiment, a wireless communication device includes first and second wireless units. The first wireless unit includes a first reception antenna and a first transmission antenna in an enclosure, transmits a first wireless signal via the first transmission antenna, and receives a second wireless signal via the first reception antenna. The second wireless unit includes a second reception antenna and a second transmission antenna in the enclosure, transmits the second wireless signal via the second transmission antenna, and receives the first wireless signal via the second reception antenna. The first and second wireless units are disposed such that value of half distance between the first and second transmission antennas is smaller than value of a smaller one among a first shortest distance between the first transmission antenna and an inner wall of the enclosure, and a second shortest distance between the second transmission antenna and the inner wall.

### CROSS-REFERENCE TO RELATED APPLICATIONS

This application is based upon and claims the benefit of priority from Japanese Patent Application No. 2014-028442, filed on Feb. 18, 2014; the entire contents of which are incorporated herein by reference.

### FIELD

Embodiments described herein relate generally to a wireless communication device.

### BACKGROUND

In recent years, wireless communication configurations with wireless communication of a signal between electronic apparatuses instead of wired communication have been employed for the purpose of wire saving in an enclosure of the apparatuses or the like. In this case, the apparatus that communicates a signal functions as a wireless communication apparatus. This configuration allows reduction of wiring in the enclosure and provides an advantage of improved flexibility in an apparatus arrangement in the enclosure.

However, while it is difficult to intercept communication signals from outside the enclosure in wired communications, there is a problem in wireless communications that a wireless signal transmitted from a wireless communication apparatus easily leaks out of the enclosure, and that the signal is easily intercepted, resulting in lower security.

### BRIEF DESCRIPTION OF THE DRAWINGS

FIG. 1 is an overall diagram of a wireless communication device according to a first embodiment;

FIG. 2 is a block diagram of a first communication unit;

FIG. 3 is a block diagram of a second communication unit;

FIG. 4 is a diagram illustrating a distance between an antenna and a wall surface of an enclosure;

FIG. 5 is a graph illustrating a relationship between a normalized distance and an electric power difference of two signals;

FIG. 6 is a diagram illustrating a case where a direction in which two communication units face each other is inclined with respect to the wall surface of the enclosure;

FIG. 7 is a diagram illustrating an arrangement of two transmission antennas at facing positions;

FIG. 8 is a diagram illustrating an exemplary arrangement of communication units in which an electric power difference of wireless signals at an observation point is larger;

FIG. 9 is a diagram illustrating a case where frequency spectra of two signals partially overlap each other;

FIG. 10 is a diagram illustrating a case where frequency spectra of two signals mostly overlap each other;

FIG. 11 is a diagram illustrating frequency spectra including out-of-band emissions;

FIG. 12 is an overall diagram of the wireless communication device according to a first modification of the first embodiment;

FIG. 13 is an overall diagram of the wireless communication device according to a second modification of the first embodiment;

FIG. 14 is an overall diagram of the wireless communication device according to a third modification of the first embodiment;

FIG. 15 is an overall diagram of the wireless communication device according to the third modification of the first embodiment;

FIG. 16 is an overall diagram of the wireless communication device according to a fourth modification of the first embodiment;

FIG. 17 is an overall diagram of the wireless communication device according to the fourth modification of the first embodiment;

FIG. 18 is an overall diagram of the wireless communication device according to a fifth modification of the first embodiment;

FIG. 19 is an overall diagram of the wireless communication device according to a second embodiment; and

FIG. 20 is an overall diagram of the wireless communication device according to a third embodiment.

### DETAILED DESCRIPTION

According to an embodiment, a wireless communication device includes a first wireless unit and a second wireless unit. The first wireless unit includes a first reception antenna and a first transmission antenna which is contained in an enclosure, transmits a first wireless signal via the first transmission antenna, and receives a second wireless signal via the first reception antenna. The second wireless unit includes a second reception antenna and a second transmission antenna which is contained in the enclosure, transmits the second wireless signal via the second transmission antenna, and receives the first wireless signal via the second reception antenna. The first wireless unit and the second wireless unit are disposed such that a value of half of a distance between the first transmission antenna and the second transmission antenna is smaller than a value of a smaller one among a first shortest distance between the first transmission antenna and an inner wall of the enclosure, and a second shortest distance between the second transmission antenna and the inner wall of the enclosure.

A wireless communication device according to embodiments will be described in detail below with reference to the drawings. In the following drawings, an identical symbol is assigned to an identical component. However, the drawings are schematic, and a relationship between thickness and a plane size, and a ratio of thickness of each layer may differ from those of an actual device. Therefore, specific thickness and a size need to be determined in consideration of the following descriptions.

### First Embodiment

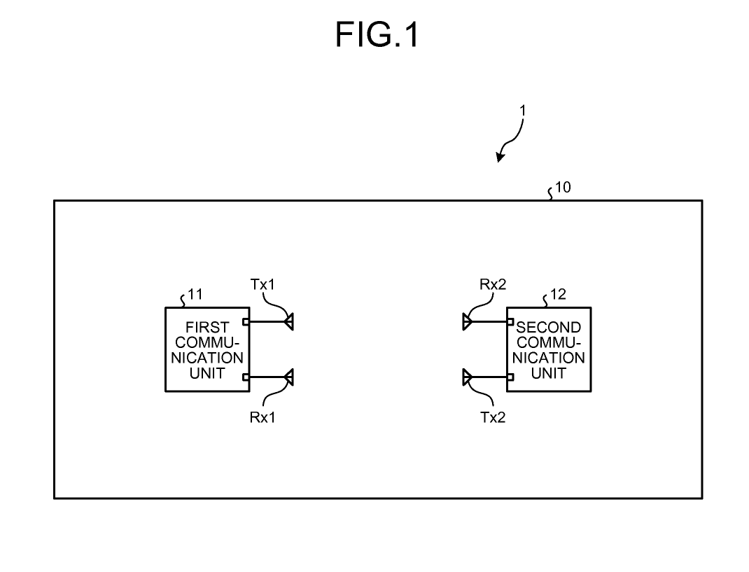

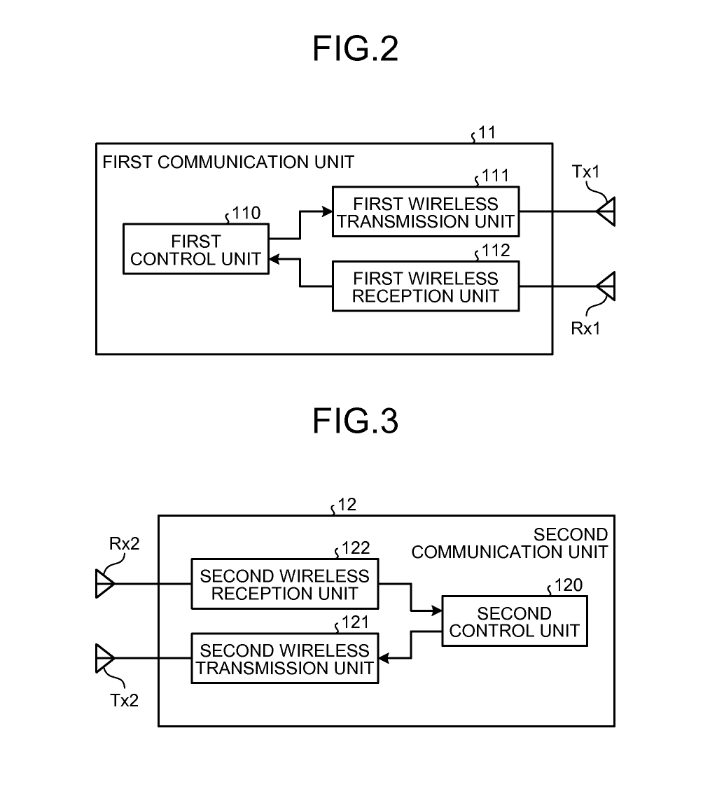

FIG. 1 is an overall diagram of a wireless communication device according to a first embodiment. FIG. 2 is a block diagram of a first communication unit. FIG. 3 is a block diagram of a second communication unit. The configuration of a wireless communication device 1 will be described with reference to FIGS. 1 to 3.

As illustrated in FIG. 1, the wireless communication device 1 includes an enclosure 10, a first communication unit 11, and a second communication unit 12. The wireless communication device 1 is a device in which the first communication unit 11 and the second communication unit 12 wirelessly communicate a signal to each other in the enclosure 10. Examples of the wireless communication device 1 include a personal computer (PC) or a server that contains an electronic board, such as a mother board, in an enclosure, and a control device that contains one or more electronic boards in an enclosure.

The enclosure 10 is a box-shaped member that contains the first communication unit 11 and the second communication unit 12. In the present embodiment, in order to explain interference of wireless signals transmitted from the first communication unit 11 and the second communication unit 12 outside the enclosure 10, it is assumed that the entire enclosure 10 is not formed of a material (for example, metal) that shields wireless signals (electric waves) and that at least part of the enclosure 10 is formed of a member that allows penetration of the wireless signals. The member that allows penetration of the wireless signals refers to, for example, a wooden member and a plastic member.

The first communication unit 11 is, for example, an electric board, and is a device for performing wireless communication with the second communication unit 12 via an antenna. As illustrated in FIG. 2, the first communication unit 11 includes a first control unit 110, a first wireless transmission unit 111, a first wireless reception unit 112, a first transmission antenna Tx1, and a first reception antenna Rx1.

The first control unit 110 is a processor for controlling a communication operation of the first wireless transmission unit 111 and the first wireless reception unit 112. The first control unit 110 passes a signal received from another electronic apparatus to the first wireless transmission unit 111 to cause the signal to be transmitted as a wireless signal (first wireless signal) via the first transmission antenna Tx1. In addition, the first control unit 110 causes the first wireless reception unit 112 to receive a wireless signal (second wireless signal) via the first reception antenna Rx1, and transmits the signal to another electronic component.

The first wireless transmission unit 111 transmits the wireless signal via the first transmission antenna Tx1 in accordance with control by the first control unit 110. The first wireless reception unit 112 receives the wireless signal via the first reception antenna Rx1 in accordance with control by the first control unit 110.

The second communication unit 12 is, for example, an electric board or the like, and is a device for performing wireless communication with the first communication unit 11 via an antenna. As illustrated in FIG. 3, the second communication unit 12 includes a second control unit 120, a second wireless transmission unit 121, a second wireless reception unit 122, a second transmission antenna Tx2, and a second reception antenna Rx2.

The second control unit 120 is a processor for controlling a communication operation of the second wireless transmission unit 121 and the second wireless reception unit 122. The second control unit 120 passes a signal received from another electronic apparatus to the second wireless transmission unit 121 to cause the signal to be transmitted as a wireless signal (second wireless signal) via the second transmission antenna Tx2. In addition, the second control unit 120 causes the second wireless reception unit 122 to receive a wireless signal (first wireless signal) via the second reception antenna Rx2, and transmits the signal to another electronic component.

The second wireless transmission unit 121 transmits the wireless signal via the second transmission antenna Tx2 in accordance with control by the second control unit 120. The second wireless reception unit 122 receives the wireless signal via the second reception antenna Rx2 in accordance with control by the second control unit 120.

With the aforementioned configuration, the first communication unit 11 transmits a wireless signal via the first transmission antenna Tx1, and the second communication unit 12 receives the wireless signal via the second reception antenna Rx2. The second communication unit 12 transmits a wireless signal via the second transmission antenna Tx2, and the first communication unit 11 receives the wireless signal via the first reception antenna Rx1. That is, the first communication unit 11 and the second communication unit 12 transmit and receive the wireless signals with each other.

When a wireless signal from the first communication unit 11 and a wireless signal from the second communication unit 12 use an identical frequency, it is impossible to perform simultaneous transmission and reception (duplex communication) due to interference. A method for enabling simultaneous transmission and reception in this case is time division duplex (TDD). TDD is a wireless communication method for achieving pseudo-simultaneous transmission and reception by switching transmission and reception in a short time, that is, by switching transmission and reception by time sharing. Another method for enabling simultaneous transmission and reception is frequency division duplex (FDD). FDD is a wireless communication method for achieving simultaneous transmission and reception by dividing frequency bands of a transmission signal and a reception signal, that is, by avoiding an overlap between frequency bands.

As described above, transmission and reception of wireless signals between the first communication unit 11 and the second communication unit 12 are possible by applying TDD or FDD. However, since wireless signals transmitted from the first communication unit 11 and the second communication unit 12 penetrate the enclosure 10 and leak out of the enclosure 10, TDD and FDD have the following problems from a viewpoint of interception of wireless signals.

Since the first communication unit 11 and the second communication unit 12 switch transmission and reception by time sharing when TDD is applied, a wireless signal from the first communication unit 11 and a wireless signal from the second communication unit 12 do not interfere with each other. Accordingly, there is a problem that it is easy to separate and intercept both wireless signals outside the enclosure 10. There is also a problem that the first communication unit 11 and the second communication unit 12 need to process complicated control for switching transmission and reception by time sharing.

On the other hand, when FDD is applied, the first communication unit 11 and the second communication unit 12 do not easily interfere with each other because the frequency bands of the wireless signal from the first communication unit 11 and the wireless signal from the second communication unit 12 are divided. Accordingly, in the same manner as in TDD, there is a problem that it is easy to separate and intercept both wireless signals outside the enclosure 10. In addition, there is a problem that the first communication unit 11 and the second communication unit 12 need mechanisms for using separate frequencies for transmitting a wireless signal and for receiving a wireless signal, resulting in higher costs.

Therefore, in order to achieve simultaneous transmission and reception, the present embodiment applies a wireless communication method (hereinafter referred to as “polarization DD”) for achieving simultaneous transmission and reception to the first communication unit 11 and the second communication unit 12 by dividing polarization of a transmission antenna and a reception antenna. In polarization DD, a polarization direction of the first transmission antenna Tx1 of the first communication unit 11 (first polarization direction) is identical to a polarization direction of the second reception antenna Rx2 of the second communication unit 12 (second polarization direction). In addition, a polarization direction of the second transmission antenna Tx2 of the second communication unit 12 (third polarization direction) is identical to a polarization direction of the first reception antenna Rx1 of the first communication unit 11 (fourth polarization direction). This enables two-way communication between the first communication unit 11 and the second communication unit 12. Furthermore, the polarization direction of the first transmission antenna Tx1 of the first communication unit 11 (second reception antenna Rx2 of the second communication unit 12) is orthogonal to the polarization direction of the first reception antenna Rx1 of the first communication unit 11 (second transmission antenna Tx2 of the second communication unit 12).

Since this causes the polarization direction of a wireless signal transmitted from the first transmission antenna Tx1 to be orthogonal to the polarization direction of a wireless signal which the first reception antenna Rx1 can receive, the wireless signal from the first communication unit 11 and the wireless signal from the second communication unit 12 do not interfere with each other even if an identical frequency is used, thereby enabling two-way communication. In addition, a wireless signal transmitted from the first communication unit 11 via the first transmission antenna Tx1 is not received via the first reception antenna Rx1. This also applies to the second transmission antenna Tx2 and the second reception antenna Rx2 of the second communication unit 12. Here, an identical polarization direction is not intended to be limited to a strictly identical direction, but is a concept including a state of an almost identical direction. Similarly, an orthogonal polarization direction is not intended to be limited to a strictly orthogonal relationship, but is a concept including a state of an almost orthogonal direction. Since polarization DD is a known technique (for example, Japanese Patent Application Laid-Open No. 2006-203541), detailed description of operation is omitted.

As described above, application of polarization DD to communication between the first communication unit 11 and the second communication unit 12 eliminates the need for complicated control processing for switching transmission and reception by time sharing like TDD, and eliminates the need for dividing a frequency band of each of wireless signals from the first communication unit 11 and the second communication unit 12 like FDD.

Since a polarization direction of a wireless signal transmitted from the first communication unit 11 is orthogonal to a polarization direction of a wireless signal transmitted from the second communication unit 12, when the wireless signals leak out of the enclosure 10 with the polarization directions of both wireless signals unchanged, it is easy to separate and intercept both wireless signals. However, since not only the first communication unit 11 and the second communication unit 12 but also other apparatuses, wiring, and the like are usually disposed in the enclosure 10, the wireless signals transmitted from the first communication unit 11 and the second communication unit 12 are reflected by these apparatuses, wiring, and the like. Reflection of a wireless signal having a predetermined polarization direction by an object usually changes the polarization direction. Accordingly, the wireless signals transmitted from the first communication unit 11 and the second communication unit 12 are randomly reflected by the apparatuses, wiring, and the like in the enclosure 10. When the wireless signals leak out of the enclosure 10, the polarization directions are usually randomized. Therefore, since both wireless signals that leak out of the enclosure 10 among the wireless signals transmitted from the first communication unit 11 and the second communication unit 12 have randomized polarization directions, it is difficult to separate and intercept both signals outside the enclosure 10.

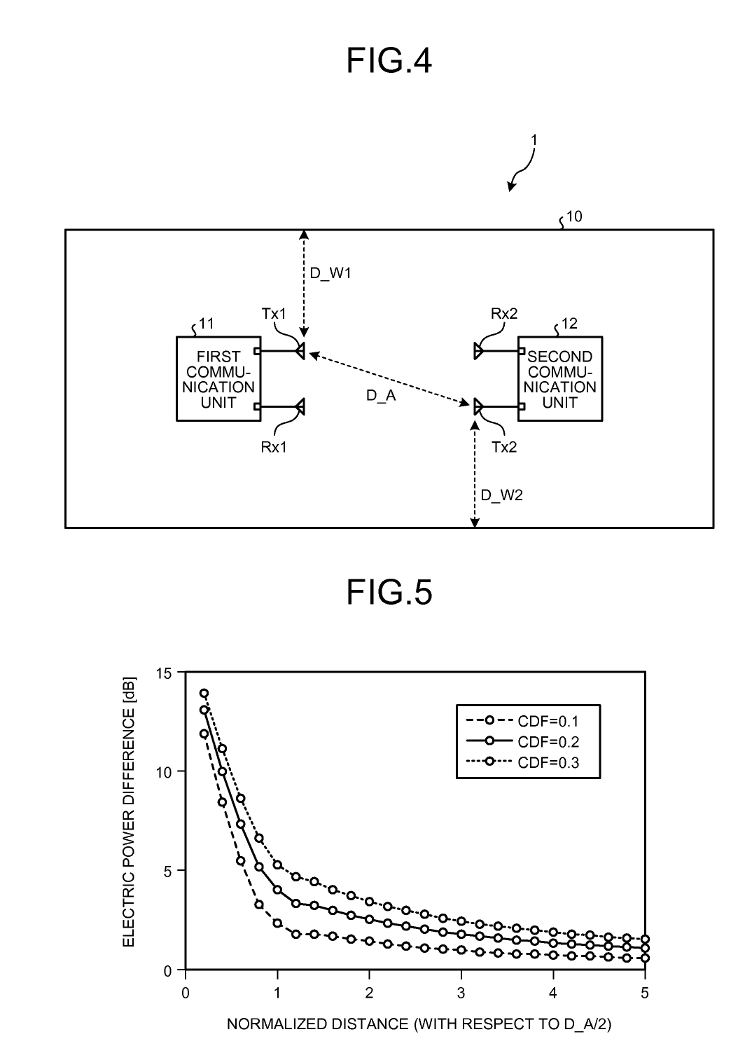

FIG. 4 is a diagram illustrating a distance between an antenna and a wall surface of an enclosure. FIG. 5 is a graph illustrating a relationship between a normalized distance and an electric power difference of two signals. With reference to FIGS. 4 and 5, a positional relationship among a wall surface of the enclosure 10, the first communication unit 11, and the second communication unit 12 in the enclosure 10 of the wireless communication device 1 will be described.

First, a point to intercept the wireless signals from the first communication unit 11 and the second communication unit 12 is referred to as an observation point. The wireless signal has a property of being attenuated at the inverse square of a distance traveled. Accordingly, when the observation point approaches one of the first transmission antenna Tx1 and the second transmission antenna Tx2, electric power of the wireless signal transmitted from the approached transmission antenna is observed to be larger, while electric power of the wireless signal transmitted from the other transmission antenna is observed to be smaller. Consequently, even though the first communication unit 11 and the second communication unit 12 transmit and receive wireless signals by polarization DD, since an electric power difference of the two wireless signals becomes larger at the observation point of the above-described position, it is easy to separate and intercept the two wireless signals at the observation point based on the larger electric power difference.

The electric power difference of the wireless signals transmitted from two points received at the observation point tends to become larger as the observation point is closer to the two points, and tends to become smaller as the observation point is more distant from the two points. This is because a ratio of a distance between the observation point and one of the two points to a distance between the observation point and the other of the two points approaches one as the observation point is distant from the two points.

As illustrated in FIG. 4, it is assumed that a distance between the first transmission antenna Tx1 and the second transmission antenna Tx2 is D_A. In addition, it is assumed that a distance obtained by normalizing, by D_A/2, a smaller distance among the distance from the observation point to the first transmission antenna Tx1 and the distance from the observation point to the second transmission antenna Tx2 is referred to as a normalized distance. For example, a normalized distance of “1” refers to a case where the observation point exists on circumferences of two circles that have an identical radius and touch each other among circles having centers at each of the first transmission antenna Tx1 and the second transmission antenna Tx2.

FIG. 5 is a graph illustrating a relationship between the normalized distance and the electric power difference [dB] at the observation point between the wireless signal from the first transmission antenna Tx1 and the wireless signal from the second transmission antenna Tx2. The electric power difference in the graph illustrated in FIG. 5 is calculated by calculating a free-space loss, that is, a loss in a situation that there is no obstacle between each antenna and the observation point using the distances from each of the first transmission antenna Tx1 and the second transmission antenna Tx2 to the observation point, and by calculating received electric power of each wireless signal. In addition, it is assumed that the wireless signal transmitted from the first transmission antenna Tx1 and the wireless signal transmitted from the second transmission antenna Tx2 have an identical electric power, and that polarization directions of the wireless signals have been fully randomized by the time the wireless signals arrive at the observation point. As described above, the wireless signals transmitted from the first communication unit 11 and the second communication unit 12 are usually reflected randomly by apparatuses, wiring, and the like in the enclosure 10. In addition, a likelihood that the polarization direction at a time of the wireless signal being transmitted will be maintained is slimmer as the distance to the observation point is longer.

Three lines in the graph illustrated in FIG. 5 are drawn when a cumulative distribution function (CDF) about the electric power difference is 0.1, 0.2, or 0.3. Here, the CDF about the electric power difference refers to a function that provides probability Pr (electric power difference≦x) for arbitrary x. The electric power difference in this case is assumed to belong to a set of electric power differences at a point of identical normalized distance. For example, the normalized distance of “1” refers to a case where the observation point exists on two circles that center on each of the above-described first transmission antenna Tx1 and the second transmission antenna Tx2, but the electric power difference differs depending on a point on the two circles. For example, when 100 sample observation points with an identical normalized distance are considered, CDF=0.1 refers to extraction of 100×0.1=10 electric power differences from among 100 electric power differences at 100 sample points from the smallest electric power difference. The line for CDF=0.1 in the graph of FIG. 5 is plotted by a simulation after extraction of a largest value from among ten (exemplary number) electric power differences extracted at respective normalized distances. The lines for CDF=0.2 and CDF=0.3 in the graph are similarly calculated.

As illustrated in the graph of FIG. 5, it will be understood that the electric power difference is smaller as the normalized distance is larger, and the electric power difference is smaller remarkably when the normalized distance is larger than “1”. In other words, at an observation point that satisfies normalized distance>1, that is, the following expression (1), the smaller electric power difference inhibits separation and interception of two wireless signals, and thus can improve security.

(D_{—}A/2)<min{(distance from observation point to first transmission antenna Tx1), (distance from observation point to second transmission antenna Tx2)} (1)

Based on the above description, as illustrated in FIG. 4, it is assumed that the first communication unit 11 and the second communication unit 12 are disposed inside the enclosure 10. That is, the observation point will inevitably exist outside the enclosure 10. As illustrated in FIG. 4, it is assumed that a shortest distance between the first transmission antenna Tx1 of the first communication unit 11 and an inner wall of the enclosure 10 is a distance D_W1 (first shortest distance), and a shortest distance between the second transmission antenna Tx2 of the second communication unit 12 and the inner wall of the enclosure 10 is a distance D_W2 (second shortest distance).

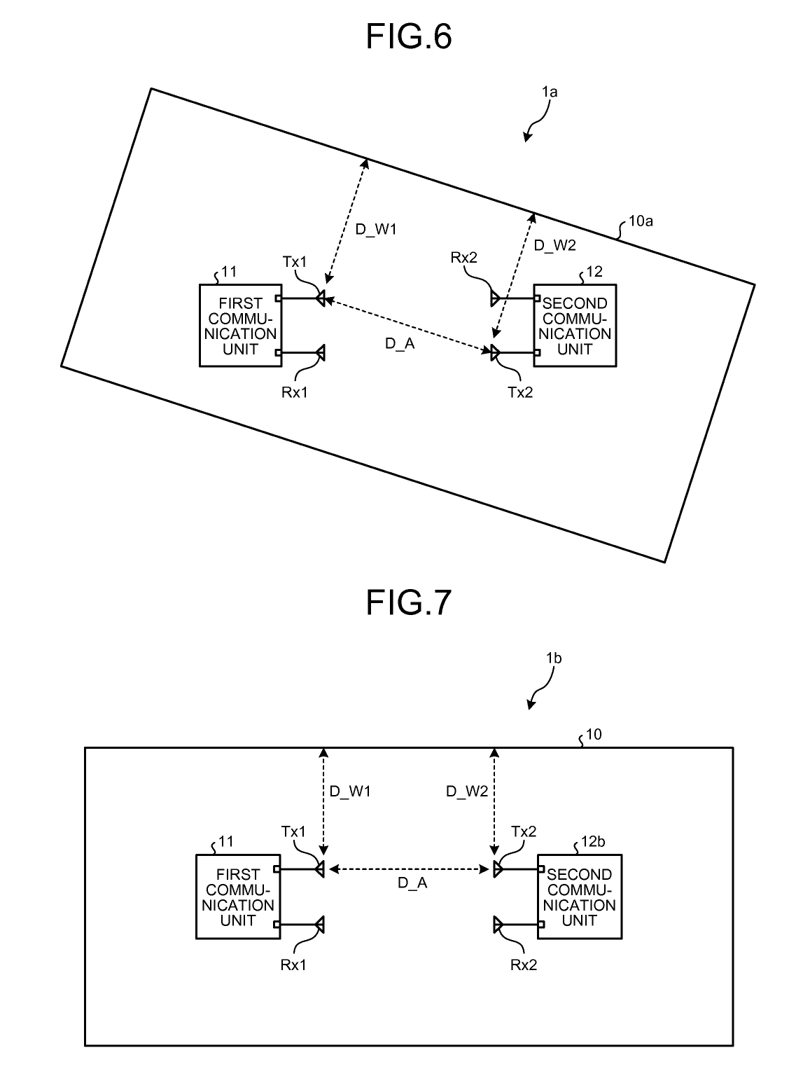

As illustrated in FIG. 6, even in a wireless communication device 1a with a direction in which the first communication unit 11 faces the second communication unit 12 being inclined with respect to a wall surface of an enclosure 10a, the distances D_A, D_W1, and D_W2 are calculated similarly. As illustrated in FIG. 7, even in a wireless communication device 1b with the first transmission antenna Tx1 of the first communication unit 11 and the second transmission antenna Tx2 of the second communication unit 12b being disposed at positions facing each other, the distances D_A, D_W1, and D_W2 are calculated similarly.

At this time, when a positional relationship among the enclosure 10, the first communication unit 11, and the second communication unit 12 satisfies the following expression (2), the above-described expression (1) is satisfied at the observation point that exists outside the enclosure 10. Specifically, the first communication unit 11 and the second communication unit 12 are disposed in the enclosure 10 such that a value of half of the distance D_A between the first transmission antenna Tx1 and the second transmission antenna Tx2 is smaller than a value of a smaller one among the shortest distance D_W1 between the first transmission antenna Tx1 and the inner wall of the enclosure 10, and the shortest distance D_W2 between the second transmission antenna Tx2 and the inner wall of the enclosure 10. In this case, at any observation point outside the enclosure 10, the smaller electric power difference inhibits separation and interception of two wireless signals, and thus can improve security.

(D_{—}A/2)<min(D_{—}W1,D_{—}W2) (2)

In the case of FIG. 7, since a direction in which the first transmission antenna Tx1 and the second transmission antenna Tx2 face each other is parallel to an inner wall surface of the enclosure 10 for calculating the distance D_W1 and the distance D_W2, it is easy to secure a distance between the first transmission antenna Tx1 and the inner wall of the enclosure 10, and a distance between the second transmission antenna Tx2 and the inner wall of the enclosure 10, thereby allowing smaller enclosure 10. Here, being parallel to the inner wall surface of the enclosure 10 is not intended to be limited to being strictly parallel but is a concept including an almost parallel state.

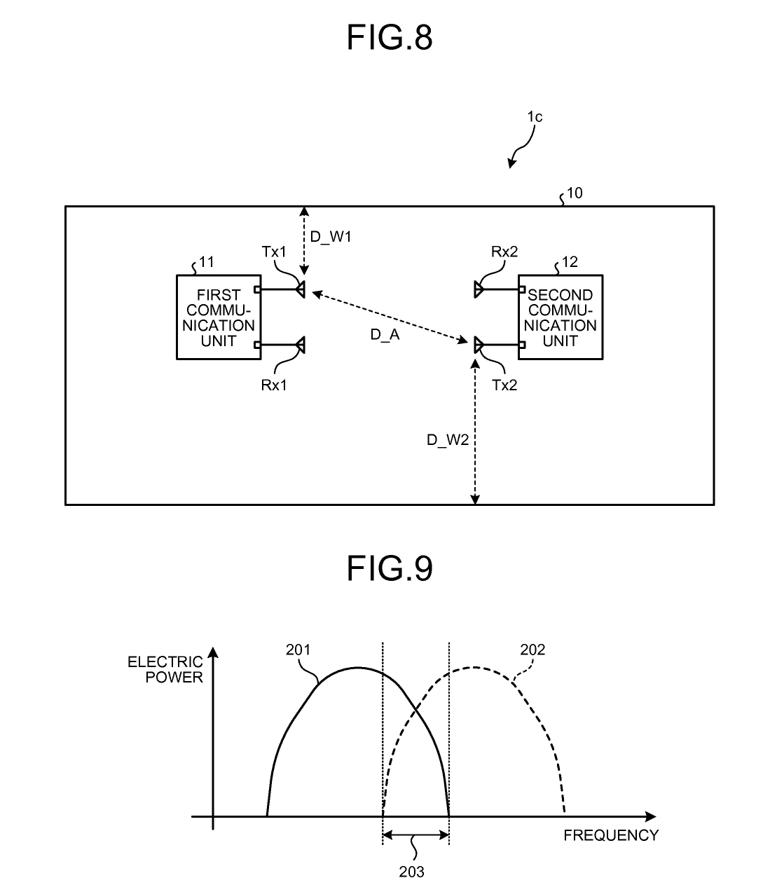

As illustrated in FIG. 8, a wireless communication device 1c in which, in the enclosure 10, the first communication unit 11 is disposed closer to the inner wall of the enclosure 10 does not satisfy the above-described expression (2), but will be in a state of the following expression (3). In this case, at an observation point outside the enclosure 10, there is a higher probability that the electric power difference of two wireless signals is larger, and it is difficult to obtain an effect of inhibition of interception as described above.

(D_{—}A/2)>min(D_{—}W1,D_{—}W2)=D_{—}W1 (3)

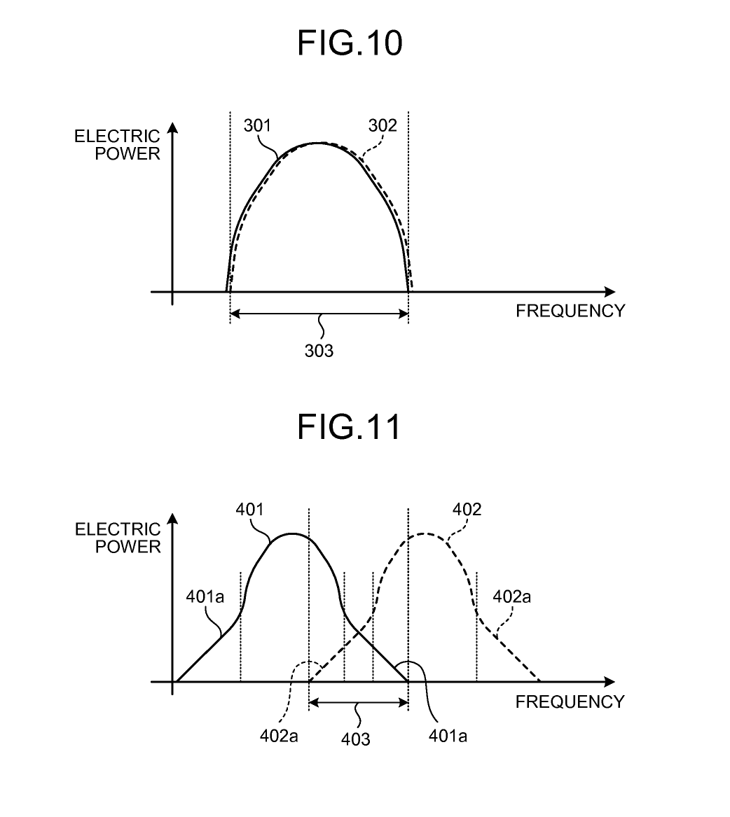

FIG. 9 is a diagram illustrating a case where frequency spectra of two signals partly overlap each other. FIG. 10 is a diagram illustrating a case where frequency spectra of two signals mostly overlap each other. FIG. 11 is a diagram illustrating frequency spectra including out-of-band emissions. A relationship between difficulty of interception of wireless signals and frequency bands of wireless signals from the first transmission antenna Tx1 and the second transmission antenna Tx2 will be described with reference to FIGS. 9 to 11.

Each of the wireless signals transmitted from the first transmission antenna Tx1 and the second transmission antenna Tx2 has a certain bandwidth about frequency (frequency band), as illustrated in FIGS. 9 and 10. From a viewpoint of inhibiting interception of the wireless signals from the first transmission antenna Tx1 and the second transmission antenna Tx2 at the observation point outside the enclosure 10, in order to cause two wireless signals to interfere with each other more efficiently, the frequency bands of the two wireless signals preferably overlap each other in a wider bandwidth. FIG. 9 illustrates an example in which a frequency spectrum 201 (first frequency spectrum) and a frequency spectrum 202 (second frequency spectrum) overlap each other in part of the band (bandwidth 203), the frequency spectrum 201 being a spectrum of the wireless signal transmitted from the first transmission antenna Tx1, the frequency spectrum 202 being a spectrum of the wireless signal transmitted from the second transmission antenna Tx2. In contrast, FIG. 10 illustrates an example in which a frequency spectrum 301 (first frequency spectrum) and a frequency spectrum 302 (second frequency spectrum) overlap each other in almost all of the frequency band, the frequency spectrum 301 being a spectrum of the wireless signal transmitted from the first transmission antenna Tx1, the frequency spectrum 302 being a spectrum of the wireless signal transmitted from the second transmission antenna Tx2. That is, the example of FIG. 10 illustrates that the frequency spectrum 301 and the frequency spectrum 302 overlap each other in a bandwidth 303 that is wider than the bandwidth 203.

As described above, in order to inhibit interception of wireless signals at an observation point and to improve security, frequency bands of two wireless signals preferably overlap each other. As illustrated in FIG. 10 rather than FIG. 9, an overlap in wider bandwidth allows more efficient interference. That is, almost identical frequency spectra of the wireless signal from the first transmission antenna Tx1 and the wireless signal from the second transmission antenna Tx2 allow the two wireless signals to interfere with each other most efficiently.

As illustrated in FIG. 11, in a frequency spectrum of a wireless signal transmitted from an antenna, an out-of-band emission close to the frequency spectrum may be generated in a process of modulation of the wireless signal. FIG. 11 illustrates an example in which both sides of a frequency spectrum 401 (first frequency spectrum) of the wireless signal from the first transmission antenna Tx1 include a generated out-of-band emission portion 401a. FIG. 11 also illustrates an example in which both sides of a frequency spectrum 402 (second frequency spectrum) of the wireless signal from the second transmission antenna Tx2 include a generated out-of-band emission portion 402a. Since this out-of-band emission has certain electric power, an overlap of the respective out-of-band emission portions of the two frequency spectra in at least a bandwidth 403 can cause the two wireless signals to interfere with each other.

In FIG. 11, both of the frequency spectrum 401 and the frequency spectrum 402 include out-of-band emission portions, but the frequency spectra are not limited to this example. That is, either one of the frequency spectrum 401 and the frequency spectrum 402 may include an out-of-band emission portion, and the out-of-band emission portion may overlap with the other frequency spectrum. This can also cause the two wireless signals to interfere with each other.

As in the above configuration, in the wireless communication device according to the present embodiment, the first communication unit 11 and the second communication unit 12 are disposed in the enclosure 10 such that a value of half of the distance D_A between the first transmission antenna Tx1 and the second transmission antenna Tx2 is smaller than a value of a smaller one among the shortest distance D_W1 between the first transmission antenna Tx1 and the inner wall of the enclosure 10, and the shortest distance D_W2 between the second transmission antenna Tx2 and the inner wall of the enclosure 10. This makes the electric power difference smaller between the wireless signal transmitted from the first transmission antenna Tx1 and the wireless signal transmitted from the second transmission antenna Tx2 at the observation point outside the enclosure 10. This inhibits separation and interception of the two wireless signals, and thus can improve security.

The wireless communication device according to the present embodiment applies polarization DD to communication between the first communication unit 11 and the second communication unit 12. That is, the polarization directions of the first transmission antenna Tx1 of the first communication unit 11 and the second reception antenna Rx2 of the second communication unit 12 are identical to each other. The polarization directions of the second transmission antenna Tx2 of the second communication unit 12 and the first reception antenna Rx1 of the first communication unit 11 are identical to each other. Moreover, the polarization direction of the first transmission antenna Tx1 of the first communication unit 11 (second reception antenna Rx2 of the second communication unit 12) and the polarization direction of the first reception antenna Rx1 of the first communication unit 11 (second transmission antenna Tx2 of the second communication unit 12) are orthogonal to each other. As a result, since the polarization direction of the wireless signal transmitted from the first transmission antenna Tx1 and the polarization direction of the wireless signal that the first reception antenna Rx1 can receive are orthogonal to each other, the wireless signal from the first communication unit 11 and the wireless signal from the second communication unit 12 do not interfere with each other, thereby allowing two-way communication. The wireless signals transmitted from the first communication unit 11 and the second communication unit 12 are randomly reflected by apparatuses, wiring, and the like in the enclosure 10, and the polarization directions are usually randomized when the signals leak out of the enclosure 10. This inhibits separation and interception of the two wireless signals outside the enclosure 10. This also eliminates the need for complicated control processing for switching transmission and reception by time sharing like TDD, and eliminates the need for dividing the frequency bands of the respective wireless signals from the first communication unit 11 and the second communication unit 12 like FDD, resulting in lower costs.

Even if the wireless signals from the first communication unit 11 and the second communication unit 12 leak out of the enclosure 10, the above configuration inhibits separation and interception of the two wireless signals, and thus can improve security. This eliminates the need for preventing the wireless signals from leaking out of the enclosure 10 by forming the inner wall of the enclosure 10 with a material such as an electromagnetic wave absorber and metal, and eliminates the need for employing an expensive member such as the electromagnetic wave absorber and the metal, resulting in lower costs. Since it is not necessary to inhibit interception by encrypting wireless signals, it is possible to prevent communication delay caused by encryption and decryption.

From a viewpoint of inhibiting interception of the wireless signal from the first communication unit 11 and the wireless signal from the second communication unit 12 at the observation point outside the enclosure 10, a period of simultaneous transmission of the two wireless signals preferably overlap each other as much as possible. This allows the two wireless signals to interfere with each other at the observation point, and thus can inhibit separation of the two wireless signals. When the first communication unit 11 and the second communication unit 12 always continue transmitting wireless signals, it is possible to cause two wireless signals to interfere with each other most efficiently. When there is no wireless signal (wireless signal containing information to communicate) to transmit, a dummy wireless signal is transmitted. This makes it possible to cause the wireless signals to interfere with each other efficiently even when a proportion of a period of transmitting a wireless signal to transmit is low.

As described above, the wireless signals transmitted from the first communication unit 11 and the second communication unit 12 usually have randomized polarization directions outside the enclosure 10. However, in order to further randomize the wireless signal, it is preferable to dispose a member other than the first communication unit 11 and the second communication unit 12 in the enclosure 10 as a reflector for the wireless signal. Examples of the member other than the first communication unit 11 and the second communication unit 12 may include a substrate, wiring, and a cooling fan. Reflection of the wireless signals by such a reflector further randomizes the polarization directions of the wireless signals transmitted from the first communication unit 11 and the second communication unit 12. This allows the two wireless signals to interfere with each other more efficiently, makes it difficult to separate the wireless signals outside the enclosure 10, and can inhibit interception of the wireless signals outside the enclosure 10.

In addition, the wireless signal that is an electric wave transmitted from each of the first communication unit 11 and the second communication unit 12 may be, for example, a microwave and a millimeter wave. The use of an electric wave with a high frequency, such as a millimeter wave, makes it easier to achieve polarization DD. Existing wireless communication standards, such as IEEE 802.11, Bluetooth (registered trademark), ZigBee (registered trademark), and TransferJet (registered trademark), may be applied to standards of the wireless communication of the first communication unit 11 and the second communication unit 12. Alternatively, a unique wireless communication method may be applied.

First Modification

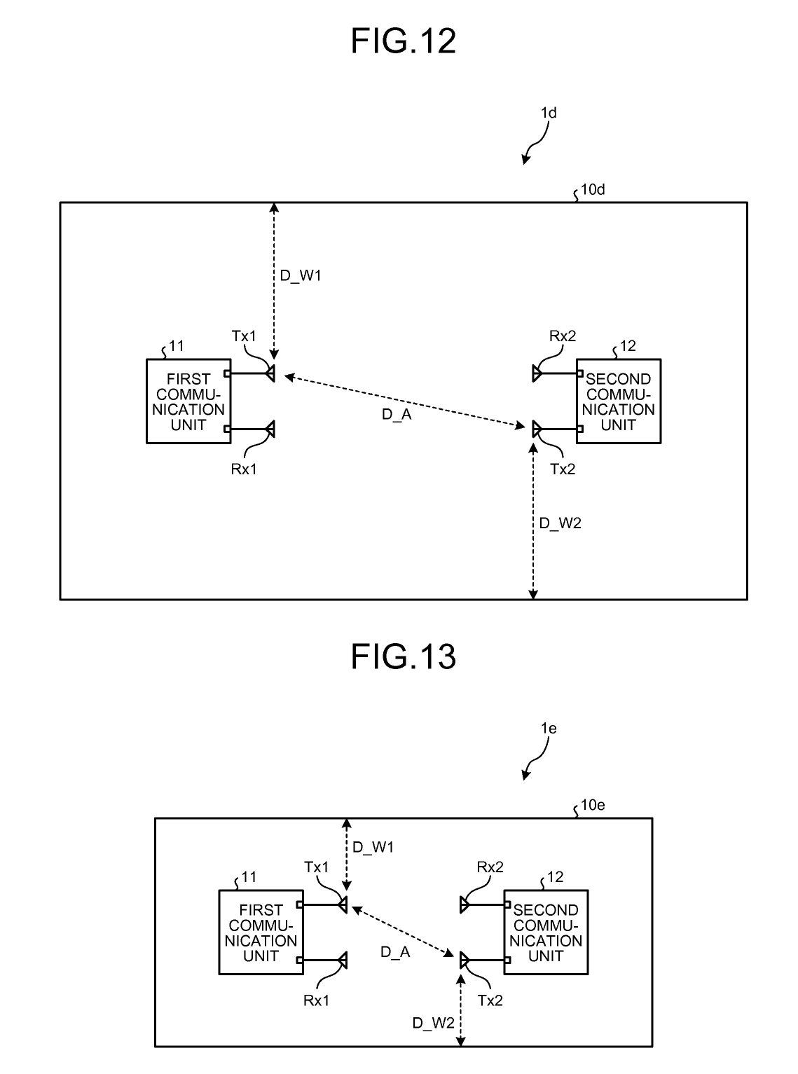

FIG. 12 is an overall diagram of a wireless communication device according to a first modification of the first embodiment. The wireless communication device according to the first modification of the first embodiment will be described with reference to FIG. 12.

Depending on constraints of specifications or physical arrangements of a first communication unit 11 and a second communication unit 12, a longer wireless communication distance, that is, a longer distance D_A, may be preferable. In this case, as illustrated in FIG. 12, the use of a larger enclosure 10d of a wireless communication device 1d allows a distance D_W1 and a distance D_W2 to be longer. Since this satisfies a condition of the above-described expression (2), an electric power difference of two wireless signals transmitted from the first communication unit 11 and the second communication unit 12 becomes smaller at an observation point outside the enclosure 10d having a larger size. This can inhibit separation and interception of the two wireless signals, and thus can improve security.

In order to satisfy the condition of the above-described expression (2), a method of installing the first communication unit 11 and the second communication unit 12 in a vicinity of a center inside the enclosure can be considered. When either one of the first transmission antenna Tx1 and the second transmission antenna Tx2 is near an inner wall of the enclosure, one of methods of satisfying the condition of the above-described expression (2) is to dispose a reception antenna at a position of the transmission antenna that is near the inner wall of the enclosure.

Second Modification

FIG. 13 is an overall diagram of a wireless communication device according to a second modification of the first embodiment. The wireless communication device according to the second modification of the first embodiment will be described with reference to FIG. 13.

Depending on an installation environment of the wireless communication device, a smaller size of an enclosure itself may be preferable. In this case, as illustrated in FIG. 13, a first communication unit 11 and a second communication unit 12 are disposed closer to each other to decrease a distance D_A inside a smaller enclosure 10e of a wireless communication device 1e. Since this satisfies the condition of the above-described expression (2), an electric power difference of two wireless signals transmitted from the first communication unit 11 and the second communication unit 12 becomes smaller even at an observation point outside the smaller enclosure 10e. This can inhibit separation and interception of the two wireless signals, and thus can improve security.

Third Modification

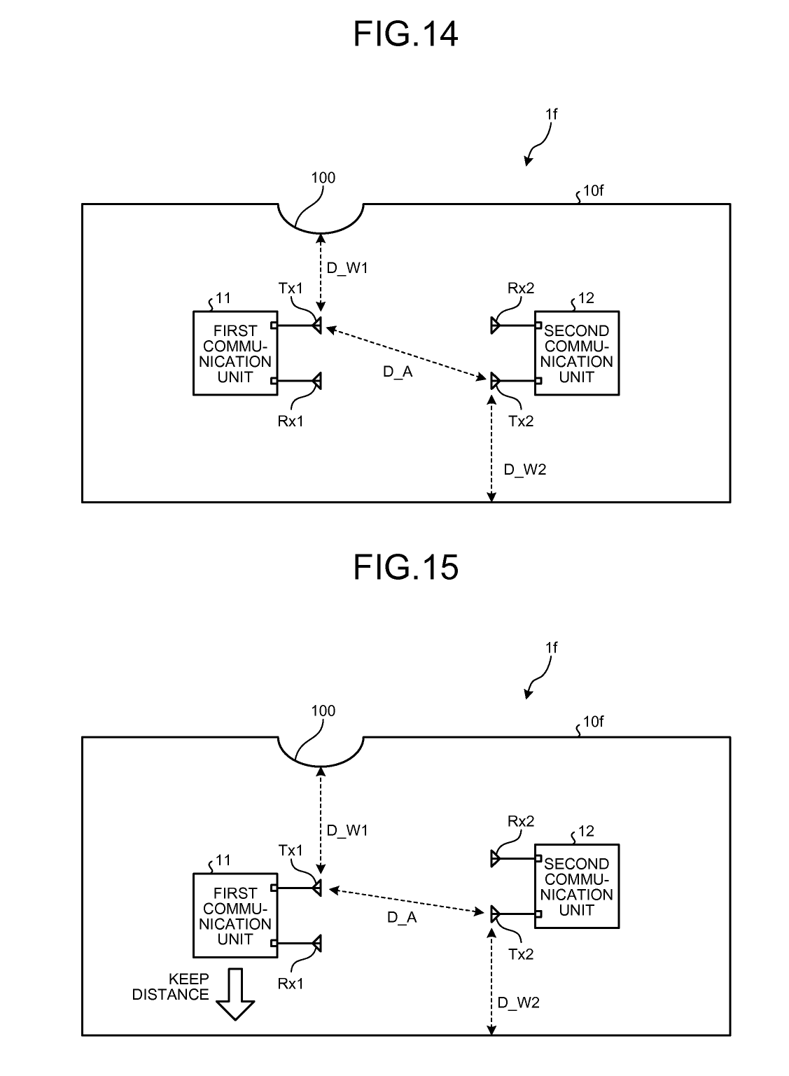

FIGS. 14 and 15 are each an overall configuration diagram of a wireless communication device according to a third modification of the first embodiment. The wireless communication device according to the third modification of the first embodiment will be described with reference to FIGS. 14 and 15.

When an enclosure containing a first communication unit 11 and a second communication unit 12 has asperities, the asperities may change a distance D_W1 or distance D_W2. FIG. 14 illustrates an example in which an enclosure 10f of a wireless communication device if has a recess 100, the shortest distance D_W1 between a first transmission antenna Tx1 and an inner wall of the enclosure 10f is smaller, and thus the condition of the above-described expression (2) is not satisfied.

In this case, as illustrated in FIG. 15, the first communication unit 11 is disposed apart from the recess 100 in the enclosure 10f to have longer distance D_W1. Since this satisfies the condition of the above-described expression (2), an electric power difference of two wireless signals transmitted from the first communication unit 11 and the second communication unit 12 becomes smaller at an observation point outside the enclosure 10f. This can inhibit separation and interception of the two wireless signals, and thus can improve security.

Fourth Modification

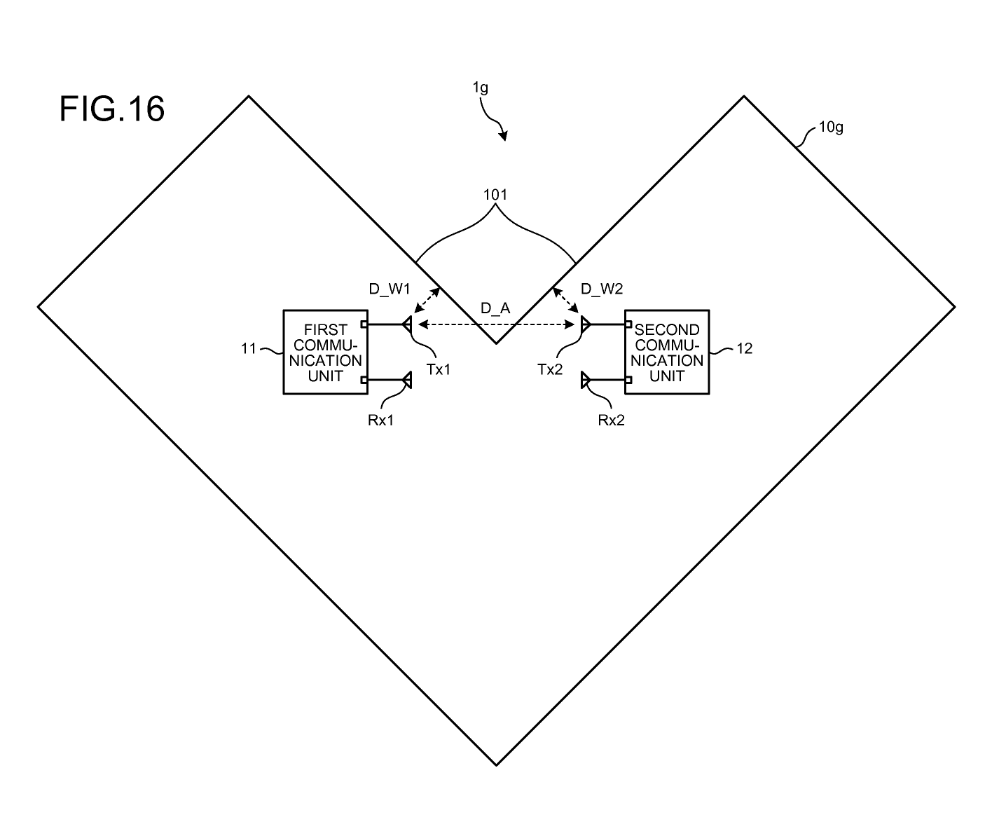

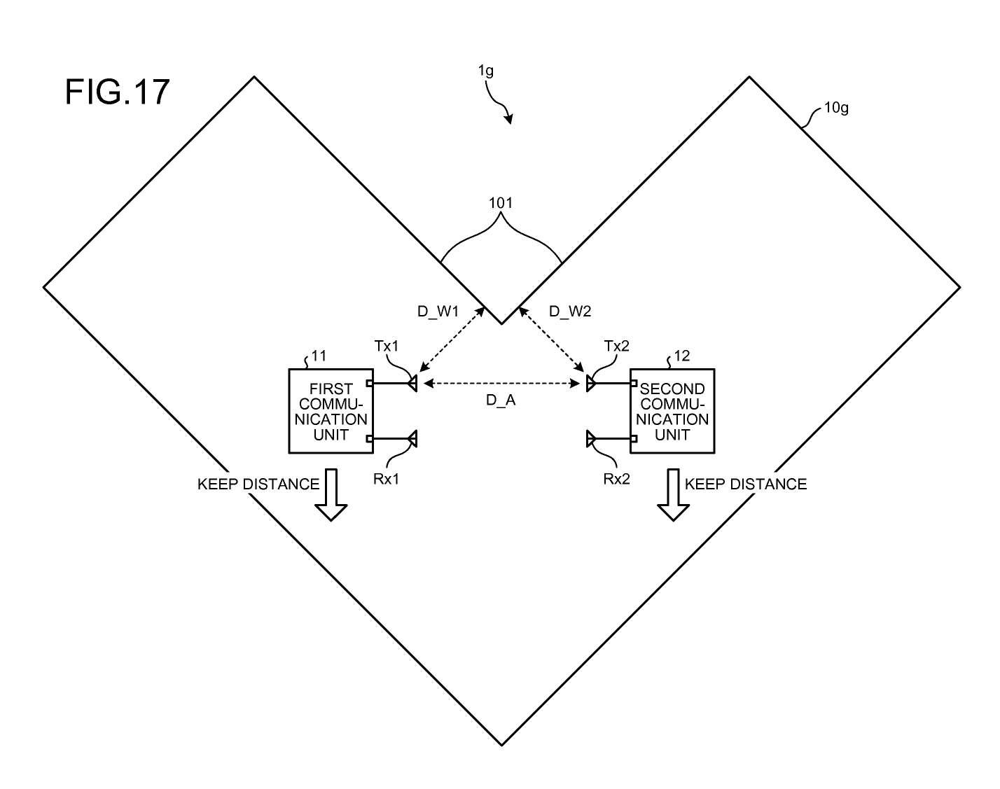

FIGS. 16 and 17 are each an overall configuration diagram of a wireless communication device according to a fourth modification of the first embodiment. The wireless communication device according to the fourth modification of the first embodiment will be described with reference to FIGS. 16 and 17.

The above-described first embodiment and the first to third modifications each describe an example in which an enclosure of the wireless communication device is rectangular. The enclosure of the wireless communication device however can have an arbitrary shape. For example, FIG. 16 illustrates a configuration of a wireless communication device 1g having an L-shaped enclosure 10g from a drawing view. Even in the wireless communication device 1g having such enclosure 10g, a method of calculating distances D_A, D_W1, and D_W2 is identical to the method in the first embodiment.

The wireless communication device 1g illustrated in FIG. 16 is arranged so that an L-shaped-portion enclosure wall 101 that is an L-shaped enclosure wall of the enclosure 10g is located between a first transmission antenna Tx1 and a second transmission antenna Tx2. This decreases the distance D_W1 and the distance D_W2, and thus does not satisfy the condition of the above-described expression (2).

In this case, as illustrated in FIG. 17, a first communication unit 11 and a second communication unit 12 are disposed in the enclosure 10g such that the first transmission antenna Tx1 and the second transmission antenna Tx2 are more distant from the L-shaped-portion enclosure wall 101 to increase the distance D_W1 and the distance D_W2. Since this satisfies the condition of the above-described expression (2), an electric power difference of two wireless signals transmitted from the first communication unit 11 and the second communication unit 12 becomes smaller at an observation point outside the enclosure 10g. This can inhibit separation and interception of the two wireless signals, and thus can improve security.

Fifth Modification

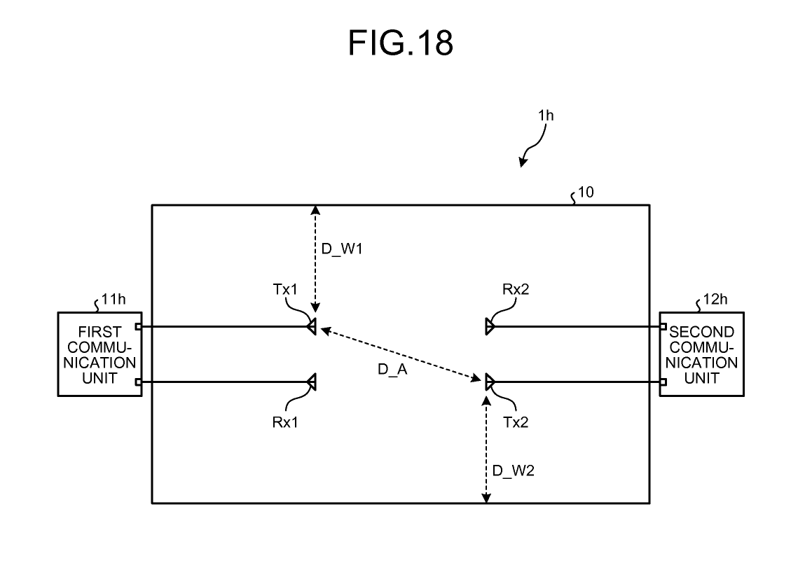

FIG. 18 is an overall diagram of a wireless communication device according to a fifth modification of the first embodiment. The wireless communication device according to the fifth modification of the first embodiment will be described with reference to FIG. 18.

In the wireless communication device according to the present embodiment, in order to obtain the above-described effect of inhibiting separation and interception of wireless signals transmitted from two transmission antennas at an observation point outside an enclosure, an arrangement of at least two transmission antennas (first transmission antenna Tx1, second transmission antenna Tx2) in the enclosure is a necessary condition. Therefore, the above-described effect can be obtained even when part or all are disposed outside the enclosure from among two reception antennas (first reception antenna Rx1, second reception antenna Rx2), a first control unit 110, a first wireless transmission unit 111, a first wireless reception unit 112, a second control unit 120, a second wireless transmission unit 121, and a second wireless reception unit 122. A wireless communication device 1h illustrated in FIG. 18 illustrates an example in which the first transmission antenna Tx1, the second transmission antenna Tx2, the first reception antenna Rx1, and the second reception antenna Rx2 are disposed inside the enclosure 10, and a first communication unit 11h and a second communication unit 12h are disposed outside the enclosure 10. Even in an arrangement illustrated in FIG. 18, since the first transmission antenna Tx1 and the second transmission antenna Tx2 are disposed inside the enclosure 10, the above-described effect can be obtained.

In addition, since components other than the first transmission antenna Tx1 and the second transmission antenna Tx2 can be disposed outside the enclosure 10, an arrangement constraint of these components decreases and design flexibility can be enhanced. In contrast, when components other than the first transmission antenna Tx1 and the second transmission antenna Tx2 are disposed inside the enclosure 10, reflection of two wireless signals easily occurs with polarization directions changed in the enclosure 10, the polarization directions are randomized, and it is possible to cause the two wireless signals to interfere with each other efficiently outside the enclosure 10.

### Second Embodiment

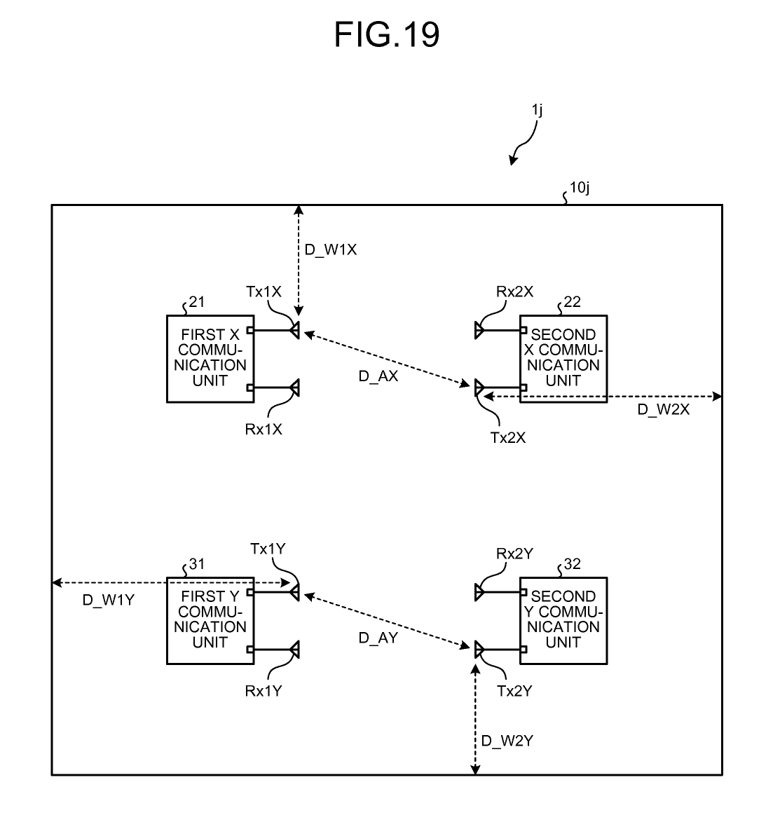

FIG. 19 is an overall diagram of a wireless communication device according to a second embodiment. A wireless communication device 1j according to the second embodiment will be described with reference to FIG. 19.

While the first embodiment describes a case where one set of communication units is contained inside an enclosure, two sets of communication units may be contained inside an enclosure 10j as illustrated in FIG. 19 of the present embodiment. Specifically, the wireless communication device 1j includes the enclosure 10j, a first X communication unit 21, a second X communication unit 22, a first Y communication unit 31, and a second Y communication unit 32. The wireless communication device 1j is a device in which, in the enclosure 10j, the first X communication unit 21 and the second X communication unit 22 wirelessly communicate a signal to each other, and the first Y communication unit 31 and the second Y communication unit 32 wirelessly communicate a signal to each other.

The first X communication unit 21 and the first Y communication unit 31 have a function similar to a function of the first communication unit 11 of the first embodiment. The first X communication unit 21 includes a first X transmission antenna Tx1X and a first X reception antenna Rx1X as antennas for wireless communication with the second X communication unit 22. The first Y communication unit 31 includes a first Y transmission antenna Tx1Y and a first Y reception antenna Rx1Y as antennas for wireless communication with the second Y communication unit 32.

The second X communication unit 22 and the second Y communication unit 32 have a function similar to a function of the second communication unit 12 of the first embodiment. The second X communication unit 22 includes a second X transmission antenna Tx2x and a second X reception antenna Rx2x as antennas for wireless communication with the first X communication unit 21. The second Y communication unit 32 includes a second Y transmission antenna Tx2Y and a second Y reception antenna Rx2Y as antennas for wireless communication with the first Y communication unit 31.

In this way, in the wireless communication device 1j including two sets of communication units, as in the first embodiment in which only one set of communication units is contained in the enclosure, respective communication units are disposed so that a distance between transmission antennas and a shortest distance between each of the transmission antennas and an inner wall of the enclosure 10j satisfy the above-described expression (2). Specifically, the first X communication unit 21 and the second X communication unit 22 are disposed so that a value of half of a distance D_AX between the first X transmission antenna Tx1X and the second X transmission antenna Tx2X is smaller than a value of a smaller one among a shortest distance D_W1X between the first X transmission antenna Tx1X and the inner wall of the enclosure 10j, and a shortest distance D_W2X between the second X transmission antenna Tx2X and the inner wall of the enclosure 10j. In addition, the first Y communication unit 31 and the second Y communication unit 32 are disposed so that a value of half of a distance D_AY between the first Y transmission antenna Tx1Y and the second Y transmission antenna Tx2Y is smaller than a value of a smaller one among a shortest distance D_W1Y between the first Y transmission antenna Tx1Y and the inner wall of the enclosure 10j, and a shortest distance D_W2Y between the second Y transmission antenna Tx2Y and the inner wall of the enclosure 10j. In this case, at any observation point outside the enclosure 10j, the electric power difference between a wireless signal transmitted from the first X transmission antenna Tx1X and a wireless signal transmitted from the second X transmission antenna Tx2X becomes smaller, and the electric power difference between a wireless signal transmitted from the first Y transmission antenna Tx1Y and a wireless signal transmitted from the second Y transmission antenna Tx2Y becomes smaller. Therefore, it is possible to inhibit separation and interception of the two wireless signals, and thus can improve security.

As illustrated in FIG. 19, when two sets of wireless units are contained and disposed adjacent to each other, for example, it is preferable to set polarization directions of adjacent antennas among antennas of the two sets of wireless units to be orthogonal to each other. For example, in the example of FIG. 19, when a set of the first X communication unit 21 and the second X communication unit 22, and a set of the first Y communication unit 31 and the second Y communication unit 32 are adjacent to each other, the polarization directions of the first Y transmission antenna Tx1Y and the first X reception antenna Rx1X are set to be orthogonal to each other. Similarly, the polarization directions of the second X transmission antenna Tx2X and the second Y reception antenna Rx2Y are set to be orthogonal to each other. Since this reduces interference between adjacent sets of communication units, an effect of improved communication quality in each set is obtained.

While FIG. 19 illustrates an example of two sets of communication units disposed in the enclosure, three or more sets of communication units may be disposed.

### Third Embodiment

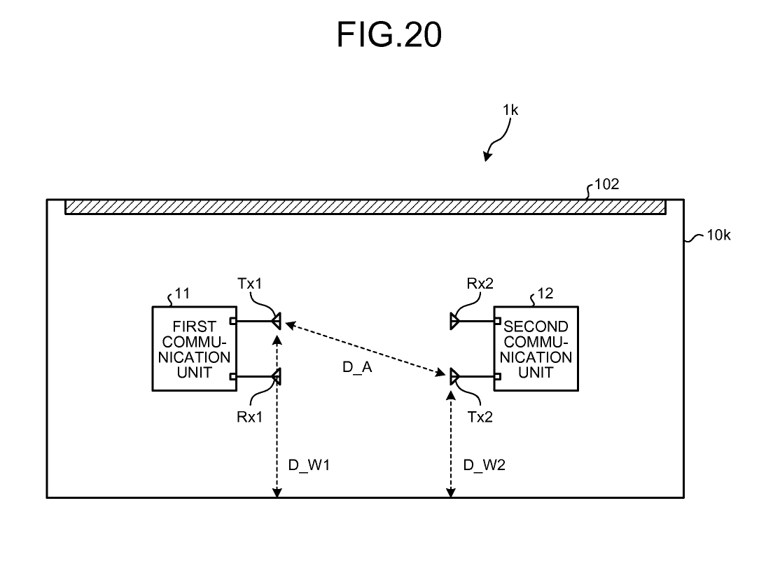

FIG. 20 is an overall diagram of a wireless communication device according to a third embodiment. With reference to FIG. 20, description of the configuration of a wireless communication device 1k according to the third embodiment focuses on a point different from the wireless communication device 1 according to the first embodiment.

As illustrated in FIG. 20, the wireless communication device 1k includes an enclosure 10k, a first communication unit 11, and a second communication unit 12.

At least part of an enclosure wall of the enclosure 10k is formed of a shielding wall for shielding an electric wave. As a shielding wall for shielding an electric wave, a metal enclosure wall, and an enclosure wall with a member having an electric wave-absorbing function affixed on an inner wall or an outer wall can be considered. In an example of FIG. 20, an upper enclosure wall of the enclosure 10k from a drawing view in FIG. 20 is formed of a shielding wall 102 for shielding an electric wave. In this case, a distance D_W1 that is a shortest distance between a first transmission antenna Tx1 and an inner wall of the enclosure 10k, and a distance D_W2 that is a shortest distance between a second transmission antenna Tx2 and the inner wall of the enclosure 10k are calculated by excluding the shielding wall 102. That is, it is not necessary to include a distance between the first transmission antenna Tx1 and the shielding wall 102, and a distance between the second transmission antenna Tx2 and the shielding wall 102 in the shortest distances. For example, in FIG. 20, a distance between the first transmission antenna Tx1 and the shielding wall 102 is the shortest distance. However, since the shielding wall 102 uses a material that shields an electric wave, a shortest distance is calculated from an enclosure wall that allows penetration of an electric wave, other than the shielding wall 102. In the case of FIG. 20, a distance between the first transmission antenna Tx1 and a lower enclosure wall from a drawing view in FIG. 20 is defined as the distance D_W1.

In this way, employment of a shielding wall that shields an electric wave in at least part of an enclosure wall of an enclosure of a wireless communication device enhances design flexibility regarding an arrangement of wireless units in the enclosure. For example, when priority is given to enhancing such design flexibility and some increase in cost is allowed, for example, when installation of wireless units near a predetermined enclosure wall in an enclosure is desired, employment of a shielding wall in the enclosure wall can satisfy the condition of the above-described expression (2).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication device comprising:
a first wireless unit that
includes a first reception antenna and a first transmission antenna which is contained in an enclosure,
transmits a first wireless signal via the first transmission antenna, and
receives a second wireless signal via the first reception antenna; and
a second wireless unit that
includes a second reception antenna and a second transmission antenna which is contained in the enclosure,
transmits the second wireless signal via the second transmission antenna, and
receives the first wireless signal via the second reception antenna, wherein
the first wireless unit and the second wireless unit are disposed such that a value of half of a distance between the first transmission antenna and the second transmission antenna is smaller than a value of a smaller one among a first shortest distance between the first transmission antenna and an inner wall of the enclosure, and a second shortest distance between the second transmission antenna and a inner wall of the enclosure.

2. The device according to claim 1, wherein a first frequency spectrum of the first wireless signal overlaps a second frequency spectrum of the second wireless signal in at least part of a bandwidth.

3. The device according to claim 2, wherein
at least one of the first frequency spectrum and the second frequency spectrum includes an out-of-band emission portion, and
a frequency spectrum including the out-of-band emission portion among the first frequency spectrum and the second frequency spectrum overlaps the other frequency spectrum in the out-of-band emission portion.

4. The device according to claim 1, further comprising a reflector that is disposed within the enclosure, and randomizes polarization directions outside the enclosure by changing the polarization directions of the first wireless signal and the second wireless signal.

5. The device according to claim 1, wherein a period in which the first wireless unit transmits the first wireless signal via the first transmission antenna, and a period in which the second wireless unit transmits the second wireless signal via the second transmission antenna overlap each other.

6. The device according to claim 5, wherein
the first wireless unit transmits a dummy wireless signal as the first wireless signal when there is no information to be included in the first wireless signal, and
the second wireless unit transmits a dummy wireless signal as the second wireless signal when there is no information to be included in the second wireless signal.

7. The device according to claim 1, wherein a direction in which the first transmission antenna and the second transmission antenna face each other is parallel to an inner wall surface of the enclosure for calculating the first shortest distance and the second shortest distance.

8. The device according to claim 1, wherein
the first transmission antenna transmits the first wireless signal in a first polarization direction,
the second reception antenna receives the first wireless signal in a second polarization direction identical to the first polarization direction,
the second transmission antenna transmits the second wireless signal in a third polarization direction,
the first reception antenna receives the second wireless signal in a fourth polarization direction identical to the third polarization direction,
the first polarization direction and the fourth polarization direction are orthogonal to each other, and
the second polarization direction and the third polarization direction are orthogonal to each other.

9. The device according to claim 1, wherein at least the first transmission antenna and the second transmission antenna are contained in the enclosure.

10. The device according to claim 1, further comprising the enclosure, wherein
at least part of an enclosure wall of the enclosure is formed of a shielding wall for shielding a wireless signal,
the first shortest distance is a shortest distance between the first transmission antenna and the enclosure wall that is not the shielding wall among the enclosure wall, and
the second shortest distance is a shortest distance between the second transmission antenna and the enclosure wall that is not the shielding wall among the enclosure wall.
